(19) United States
(12) Patent Application Publication
(10) Pub. No.: US 2011/0071845 A1
(43) Pub. Date: Mar. 24, 2011

(54) COMPUTER BASED STANDARDIZED METHOD AND APPARATUS FOR GUIDING DECISION SUPPORT FOR SURGICAL ANATOMIC PATHOLOGY OPERATIONS

(76) Inventor: Heidi E. Wagner, Buffalo, NY (US)

(21) Appl. No.: 12/890,139

(22) Filed: Sep. 24, 2010

Related U.S. Application Data
(60) Provisional application No. 61/245,468, filed on Sep. 24, 2009.

(51) Int. Cl. G06Q 50/00

(52) U.S. Cl. 705/2

(57) ABSTRACT

A computer-based method for guiding decision support for surgical anatomic pathology operations, including: displaying, using a GUI for at least one specially programmed computer, a list of human body organs or organ systems; displaying, using the GUI, a list including at least one specimen type applicable to a selected human body organ or organ system; populating, using the GUI and the processor, a field with instructions, from a plurality of instructions, for guiding a surgical anatomic pathology operation applicable to a selected specimen type; displaying, using the GUI and the processor, a dictation template with respective prompts and respective fields applicable to the surgical anatomic pathology operation; receiving, using the GUI, an input from the respective fields including data related to performance of the surgical anatomic pathology operation; and generating, using the processor, a pathology report for the existing patient or the new patient including the data.

### CROSS-REFERENCE TO RELATED APPLICATIONS

This application claims the benefit under 35 U.S.C. §119(e) of U.S. Provisional Application No. 61/245,468 filed Sep. 24, 2009 which application is incorporated herein by reference.

### REFERENCE TO COMPUTER PROGRAM LISTING APPENDIX

The present application includes a computer program listing in ASCII text file format as follows. The computer program listing is hereby expressly incorporated by reference in the present application.

| Filename | Size | Date Created |
|---|---|---|
| form1.txt | 35 kb | Sep. 23, 2010 |
| form2.txt | 1 kb | Sep. 23, 2010 |
| form3.txt | 2 kb | Sep. 23, 2010 |

### FIELD OF THE DISCLOSURE

The present disclosure relates generally to a standardized computer based method and apparatus for guiding decision support for surgical anatomic pathology operations.

### BACKGROUND OF THE DISCLOSURE

U.S. Patent Application Publication No. 2008/0242953 (Dew et al.) discloses a computer-based method and system for presenting prompts for medical personnel performing patient examinations. This reference is directed to a diagnostic operation regarding a patient and has no teaching, suggestion, or motivation directed to surgical anatomic pathology operations, in particular, guiding decision support for surgical anatomic pathology operations.

U.S. Patent Application Publication No. 2009/0222746 (Chirica et al.) discloses a computer-based method and system for controlling workflow in a pathology laboratory. Chirica defines workflow as a path or an order of operations that a specimen may follow in a laboratory. Thus, any actual medical operations included in the workflow, for example, operations at a grossing station, can be considered “black boxes.” Chirica is concerned with how the black boxes are handled and there is no standardized teaching, suggestion, or motivation regarding what is happening inside the black boxes. For example, Chirica has no standardized teaching, suggestion, or motivation regarding how a surgical grossing operation is actually performed.

In fact, Chirica teaches away from providing any type of information regarding actual execution of a medical procedure, since Chirica is only concerned with the “black boxes” (operational/systemic concerns). For example, Chirica has no standardized teaching, suggestion, or motivation as to how a grossing operation is performed. Chirica is only concerned with the flow of a specimen, irrespective of the actual operations performed on the specimen, through a grossing station, that is, how the “black box” is handled. In fact, providing any type of instruction or information guiding decision support for surgical anatomic pathology operations in Chirica would change the principle of operation of Chirica (focusing on work flow information, which is at an entirely different level than actual medical operation procedures) and would render Chirica unsatisfactory for its intended purpose (controlling work flow), as such information as no bearing or relevance with respect to work flow and could only serve to confuse or hinder the control of work flow operations and add undesirable and unnecessary complexity and cost.

U.S. Patent Application Publication No. 2008/0249386 (Besterman et al.) teaches a computer-based method and system for providing instructions to control a patient's physiological status. This reference has no teaching, suggestion, or motivation applicable to standardized surgical anatomic pathology operations, in particular, guiding decision support for surgical anatomic pathology operations.

U.S. Patent Application Publication No. 2003/0061070 (Kelly et al.) teaches a computer-based method and system for medical training. This reference is directed to abstract, theoretical teaching, not to guidance for any type of actual medical operation, and has no teaching, suggestion, or motivation directed to surgical anatomic pathology operations, in particular, guiding decision support for surgical anatomic pathology operations.

### SUMMARY OF THE DISCLOSURE

According to aspects illustrated herein, there is provided a computer-based method for guiding decision support for surgical anatomic pathology operations, including: storing, in a memory element of at least one specially programmed computer, a plurality of instructions for guiding surgical anatomic pathology operations; receiving, using a graphical user interface (GUI) for the at least one specially programmed computer, an input selecting an existing patient or identifying a new patient; displaying, using the GUI and a processor for the at least one specially programmed computer, a list of human body organs or organ systems; receiving, using the GUI, an input selecting an organ or organ system from the list of human body organs or organ systems; displaying, using the GUI and the processor, a list including at least one specimen type applicable to the selected human body organ or organ system; receiving, using the GUI, an input selecting a specimen type from the list including at least one specimen type; populating, using the GUI and the processor, a first field with instructions, from the plurality of instructions, for guiding a surgical anatomic pathology operation applicable to the selected specimen type; displaying, using the GUI and the processor, a dictation template with respective prompts and respective fields applicable to the surgical anatomic pathology operation; receiving, using the GUI, an input from the respective fields including first data related to performance of the surgical anatomic pathology operation; and generating, using the processor, a pathology report for the existing patient or the new patient including the first data.

According to aspects illustrated herein, there is provided a computer-based apparatus for guiding decision support for surgical anatomic pathology operations, including: a memory element for at least one specially programmed computer; a processor for the at least one specially programmed computer; and a graphical user interface (GUI) for the at least one specially programmed computer. The memory element is for storing a plurality of instructions for guiding surgical anatomic pathology operations. The GUI is for: receiving an input selecting an existing patient or identifying a new patient; displaying, using the processor, a list of human body organs or organ systems; receiving an input selecting an organ or organ system from the list of human body organs or organ systems; displaying, using the processor, a list including at least one specimen type applicable to the selected human body organ or organ system; and receiving an input selecting a specimen type from the list including at least one specimen type. The processor is for populating, using the GUI, a first field with instructions, from the plurality of instructions, for guiding a surgical anatomic pathology operation applicable to the selected specimen type. The GUI is for: displaying, using the processor, a dictation template with respective prompts and respective fields applicable to the surgical anatomic pathology operation; and receiving an input from the respective fields including first data related to performance of the surgical anatomic pathology operation. The processor is for generating a pathology report for the existing patient or the new patient including the first data.

### BRIEF DESCRIPTION OF THE DRAWINGS

The nature and mode of operation of the present disclosure will now be more fully described in the following detailed description of the disclosure taken with the accompanying drawing figures, in which:

FIGS. 1 through 13 are pictures of a graphical user interface screen illustrating a computer based method and apparatus for guiding decision support for surgical anatomic pathology operations; and,

FIG. 14 is a schematic block diagram of a computer-based apparatus for guiding decision support for surgical anatomic pathology operations.

### DETAILED DESCRIPTION OF THE PREFERRED EMBODIMENT

It is to be understood that the disclosure is not limited to the disclosed aspects. Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It is to be understood that any methods, devices or materials similar or equivalent to those described herein can be used in the practice or testing of the disclosure.

The present disclosure includes a computer-based method and apparatus for guiding decision support for surgical anatomic pathology operations. The method and apparatus are directed to medical personnel, for example, Fellows, Residents, Pathologist Assistants and Pathologist Assistants students, who are performing surgical anatomic pathology operations. In one embodiment, the method and apparatus enable individual medical facilities to customize pre-formatted standard template guidelines and forced data entry standardized dictations for gross surgical anatomic pathology. The method and apparatus can be used as a stand alone apparatus or it can interface with current facility pathology software, for example, CoPathPlus Cerner, CoPath Sunquest, Cerner Classic, Cerner Millenium, and PowerPath/IMPAC.

In one embodiment, when initiating the standardized method and apparatus, the user can access an existing patient file by searching for the patient name, the medical record number, the social security number or the pathology surgical case number. In one embodiment, the user can create a new surgical pathology file for a new patient by entering patient name, medical record number, social security number or other patient demographics, all following HIPAA compliance. Thus, the user can search through existing patient files or create a new patient file.

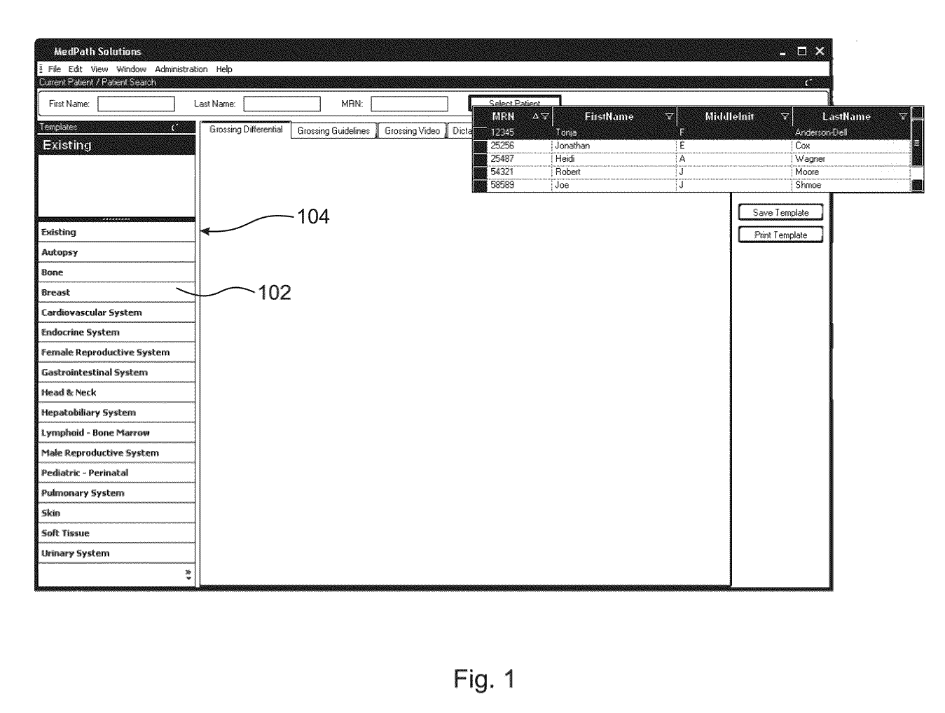

FIG. 1 is a picture of a base screen for the standardized computer-based apparatus for guiding decision support for surgical anatomic pathology operations for trained medical personnel. This screen is used to select an existing patient or create a file for a new patient. The discussion that follows is directed to an existing patient; however, it should be understood that the discussion is applicable to a new patient.

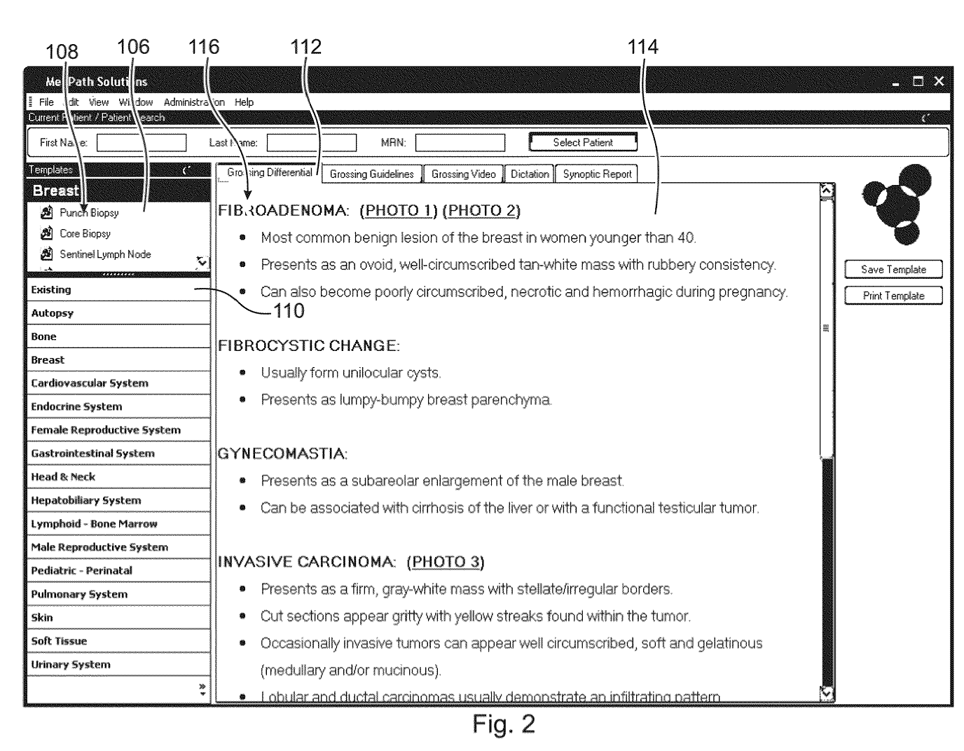

To generate FIG. 2, the user has selected tab 102 for “Breast” from the listing of human body organs and organ systems in field 104 in the previous screen. Any organ or organ system known in the art can be included in field 104. Also, a new menu labeled “Breast” appears in field 106 above the listing in field 104. The new menu presents specimen types 108 in field 106. To view existing files regarding the selected patient tab 110 for “Existing” is selected. The user also has selected Tab 112 for “Grossing Differential” in FIG. 2. As a result, field 114, the Grossing Differential field has been populated with information applicable to the organ or organ system selected in the previous figure, for example, the apparatus has populated the Grossing Differential viewing field with standardized prompts and differential information 116 applicable to a breast specimen. Standardized prompts and differential information 116 provide pictorial and standardized written descriptions regarding all possible non-neoplastic and neoplastic specimen type scenarios applicable to the selected organ or organ system.

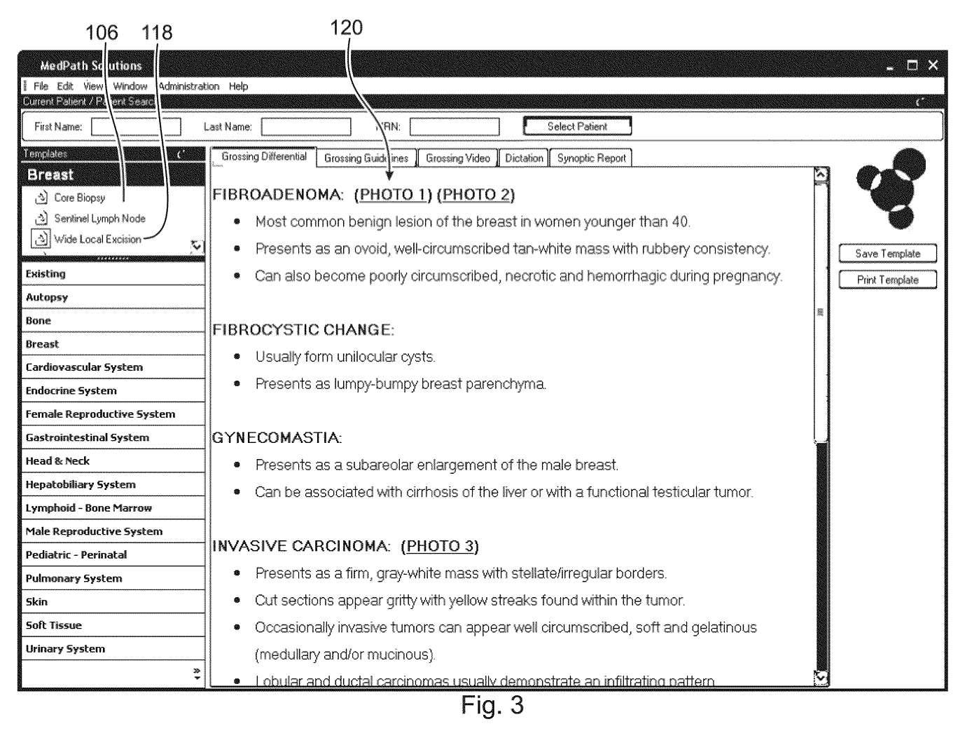

In FIG. 3, the user has selected tab 118 for “Wide Local Excision” from the specimen option menu in field 106. In the example shown, standardized prompts and differential information 116 are the same for the organ or organ system selected and the specimen type selected. In some instances, standardized prompts and differential information 116 change for the specimen type selected, and the applicable standardized prompts and differential information are presented in response to the selection of the specimen type.

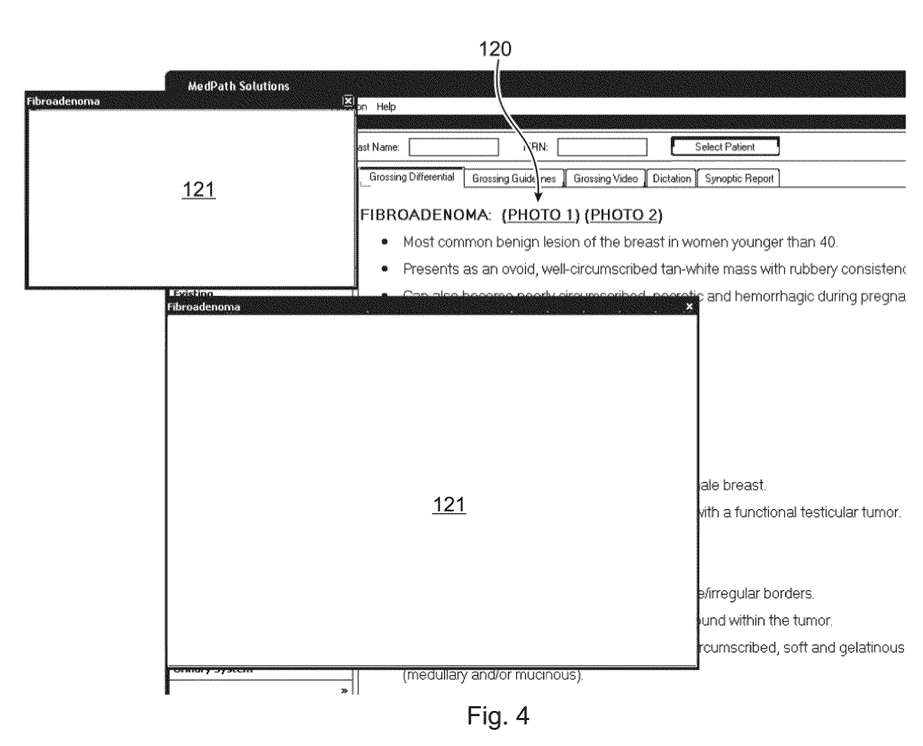

To generate the photographs shown in FIG. 4, the user selected the photograph links in the viewing field, for example, PHOTO 1 or PHOTO 2 120, as shown in FIG. 3, as applicable to the selected organ or organ system. In one embodiment, standardized prompts and differential information 116 includes respective links to an interactive photograph of the affiliated typical gross photograph of the organ or organ system selected relating to the differential information. In FIG. 4, photographs would be displayed in blank fields 121. Any pictorial information known in the art can be displayed in fields creating a pathology specimen library within the apparatus. It should be understood that the present disclosure is not limited to the number of fields 121 shown.

In one embodiment, these interactive photo links, for example, PHOTO 1 or PHOTO 2, once opened, provide a separate web based link enabling pathology case studies affiliated with the type of chosen interactive photo, for example in PHOTO 1-fibroadenoma. These case studies are accredited through any accrediting entity known in the art, such as American Association of Pathologists Assistants, American Society of Clinical Pathology, and College of American Pathologists. These case studies can be completed by the user, for example, the user answers questions presented as part of the case study, for purposes of obtaining continuing medical education credits. Thus, the present disclosure offers a mechanism for generating facility specific continuing medical education credits.

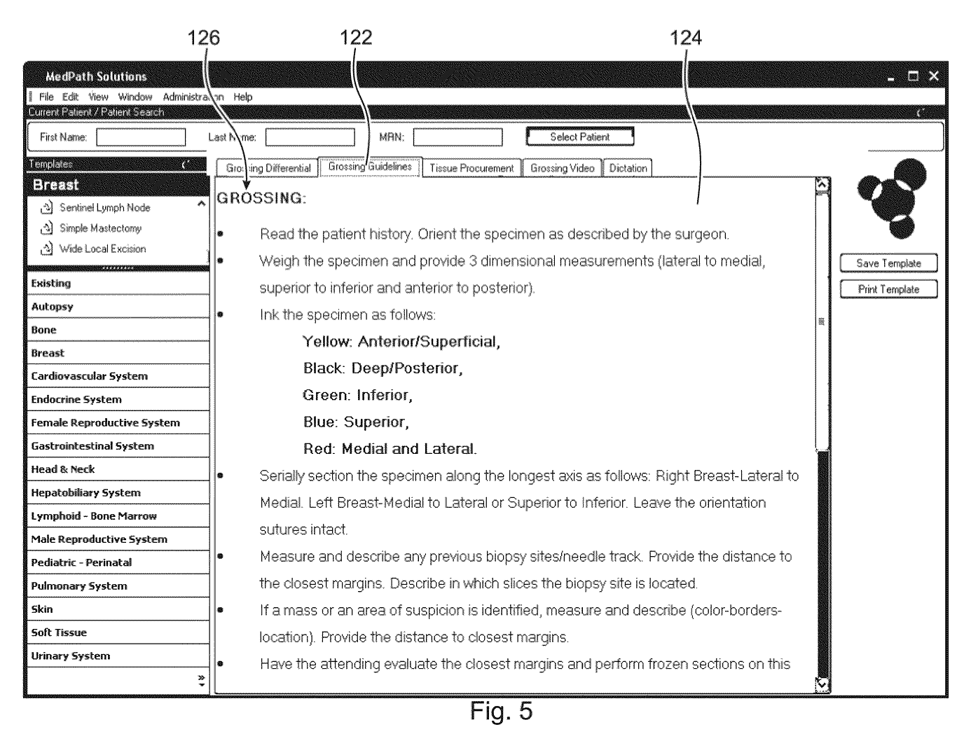

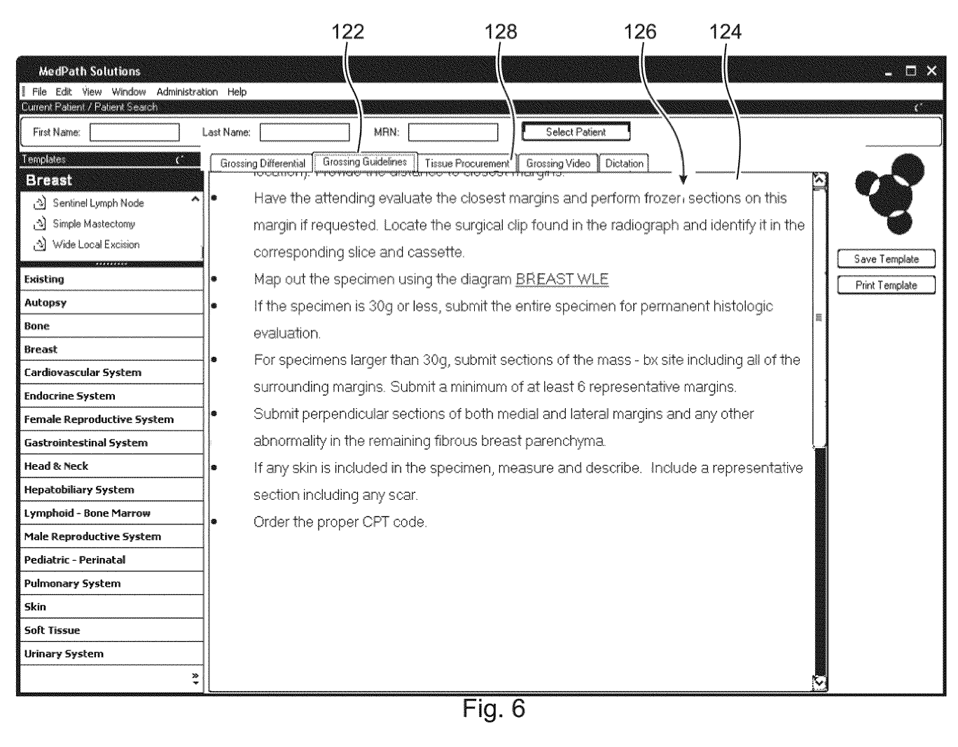

To generate FIGS. 5 and 6, the user selected tab 122 for “Grossing Guidelines” in FIG. 5. Field 124, the Grossing Guidelines field, has been populated with standardized instructions, or guidelines, 126 for a surgical anatomic pathology operation applicable to the selected specimen type. In one embodiment, instructions or guidelines 126 assume the user is generally proficient or competent in surgical anatomic pathology operation procedures, and instructions or guidelines 126 direct or guide the user as to how to apply this proficiency or competence in a particular setting, specifically, for a particular surgical anatomic pathology operation. That is, instructions or guidelines 126 are not for training a user to obtain proficiency, but rather are for directing an already proficient user. As an analogy, instructions or guidelines 126 would not train a user as to how operate a motor vehicle, for example, make turns with the vehicle; but rather would guide the user as to where and when to turn the vehicle. In one embodiment, instructions or guidelines 126 do not assume that the user is generally proficient or competent in surgical anatomic pathology operation procedures, and instructions or guidelines 126 provide training and instruction to obtain this proficiency or competence, as well as directions for applying obtained proficiency or competence. In one embodiment, populated field 124 provides a detailed, facility customizable list of how to gross the chosen specimen. A suggested number of sections and required cassettes to be submitted for tissue processing is displayed according to the specimen type selected.

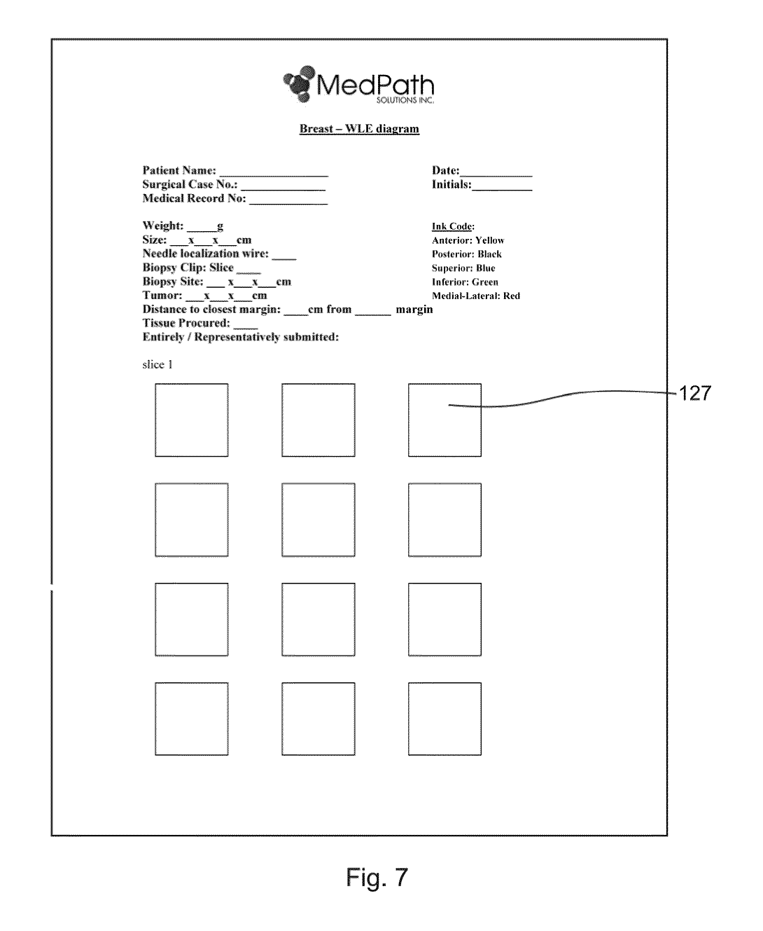

For the specimens that require an organ specific diagram-map, in this example, a Wide Local Excision organ specific diagram-map, a link to the diagram will automatically populate to generate the diagram shown in FIG. 7. Once the diagram is enabled, the patient demographics will populate on to the organ specific diagram-map along with the date of the pathology report and the user signature. The user can enable the print button allowing the user to print out the specimen diagram and map out the selected sections sampled from the specimen, for example, in fields 127. Once the organ specific diagram is completed, the user can input the diagram for inclusion in the patient file.

In one embodiment (not shown), a touch screen is used in the apparatus and the organ specific diagram-map selected via FIGS. 5 and 6 opens in “draw” section shown in FIG. 7 that can be completed on the screen and saved to the patient file. If the specimen is radiographed, the radiograph is accessible within the patient file and the user is able to map the specimen using touch screen capabilities.

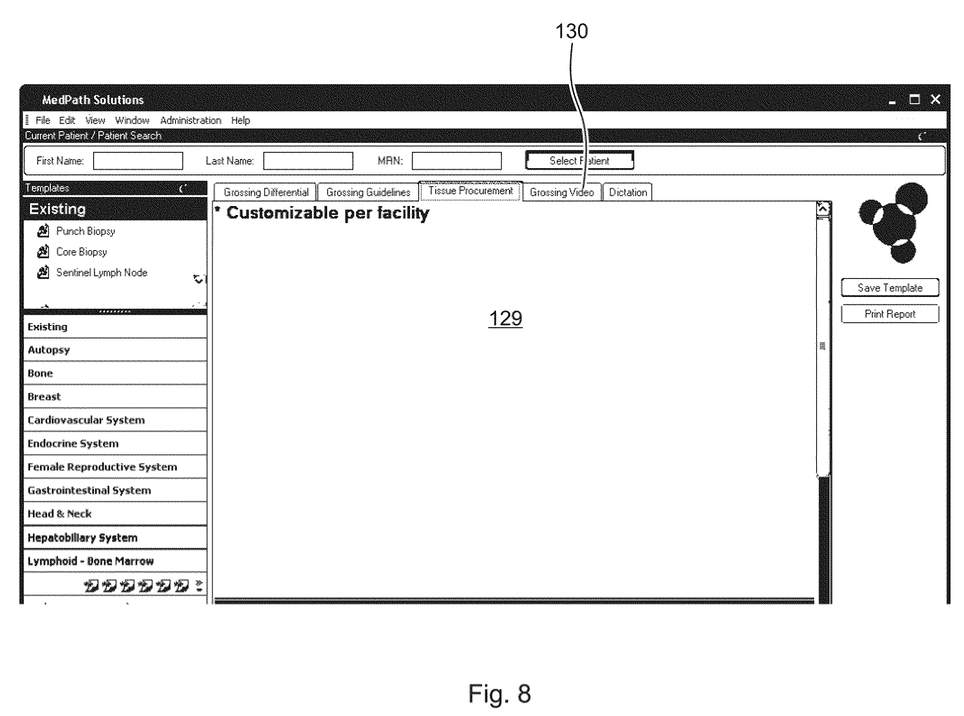

To generate FIG. 8, tab 128 for Tissue Procurement tab has been selected in FIG. 6. Facility customizable standardized instructions and protocols to procure tissue for research and clinical data analysis are presented in field 129. The standardized instructions and protocols are specimen type specific. Note that blank field 129 can be customized by a user to display any graphical presentation known in the art regarding tissue procurement.

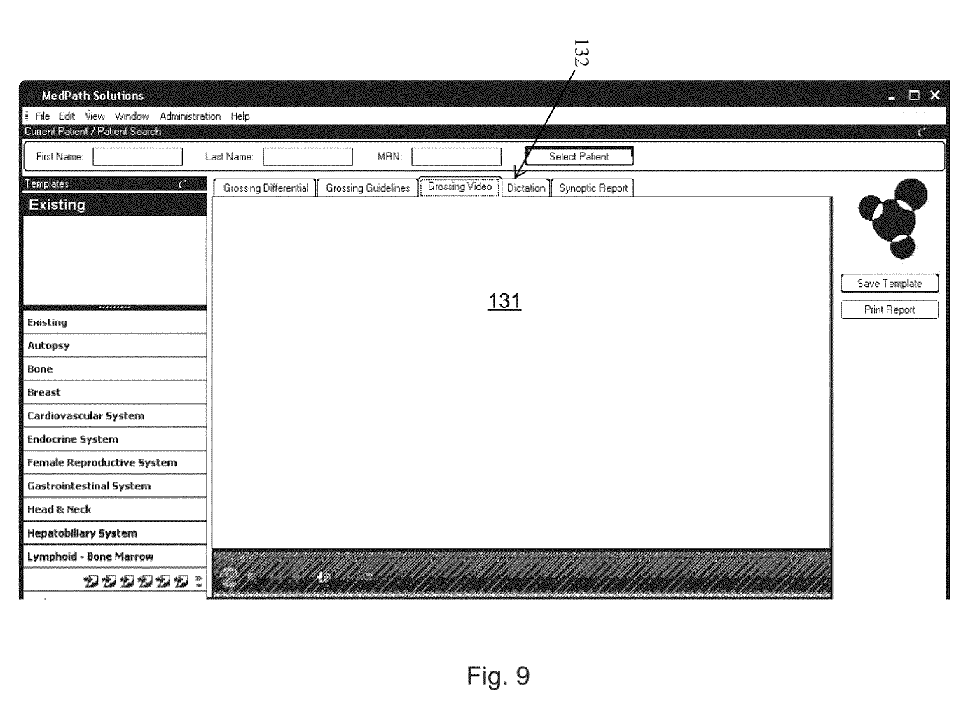

To generate FIG. 9, the user selected tab 130 for Grossing Video in FIG. 8. In FIG. 9, videos demonstrating how to gross the chosen specimen would be displayed in blank field 131. It should be understood that the present disclosure is not limited to the number of fields 131 shown. The video is presented using any means known in the art, for example, a flash media player.

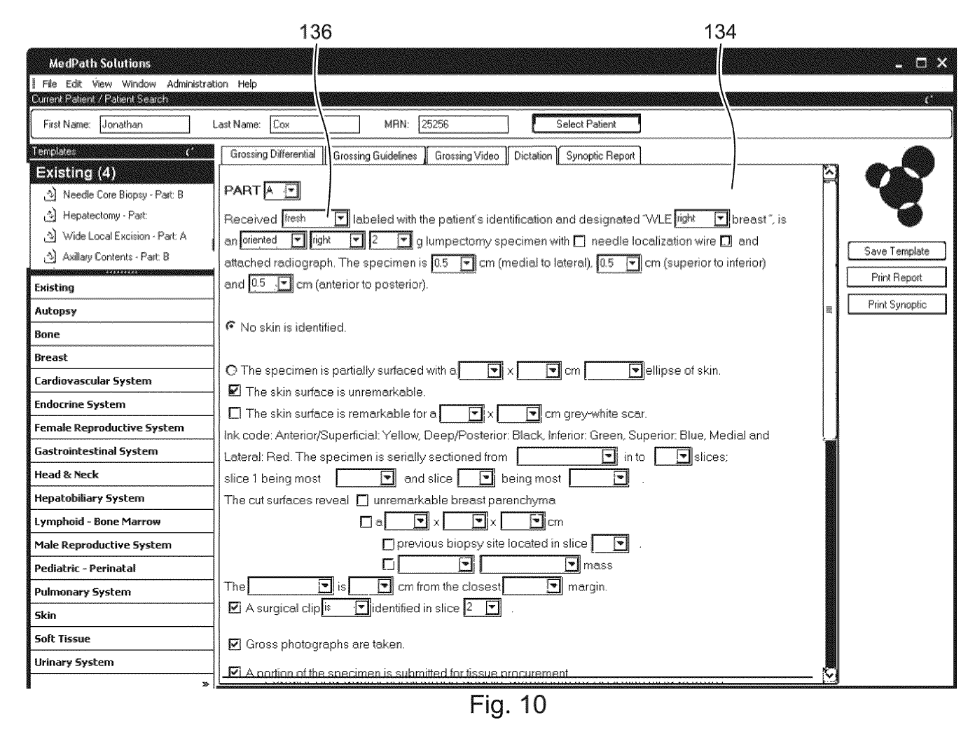

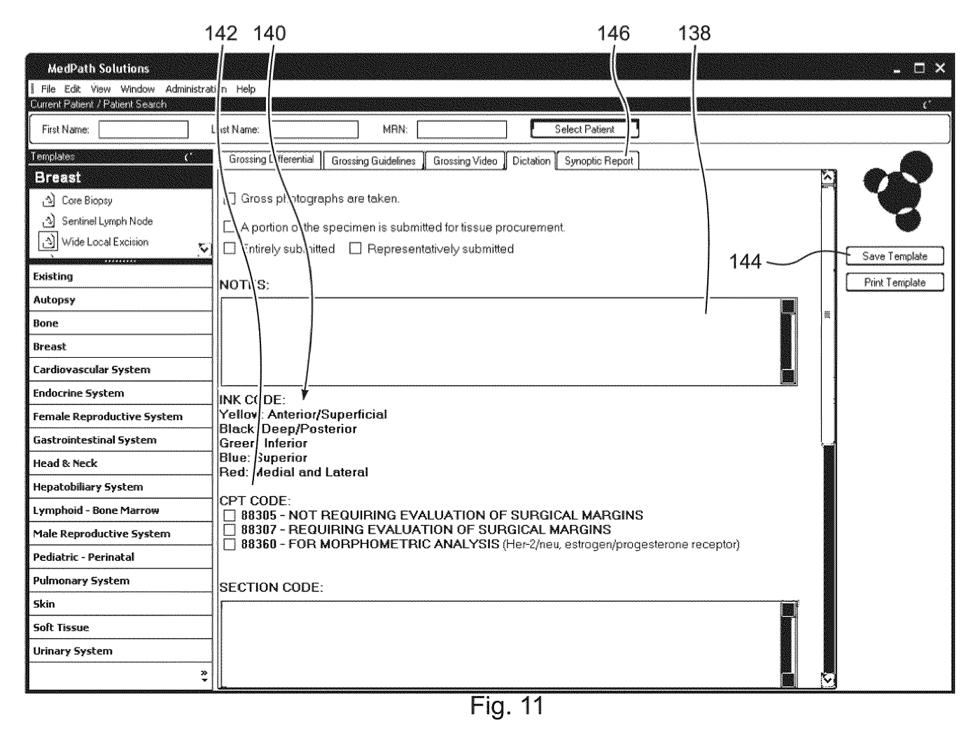

To generate FIGS. 10 and 11, the user selected tab 132 for Dictation in FIG. 9 and field 134 is populated with a facility customizable standardized dictation template according to the specimen type chosen and applicable surgical anatomic pathology operation. The template can be opened and completed using any means known in the art, for example, mouse clicks, keyboard commands, voice recognition commands (such as Dragon Naturally Speaking Medical), or touch screen. In one embodiment, the templates are generated in a way that the user cannot move forward through the dictation without the required information being completed, for example, the user cannot finalize the patient report until all required fields 136 in FIGS. 10 and 11 are completed.

If a gross photograph of the patient specimen is required, the apparatus accepts the photograph as input. The user can input the photo file to the patient file using an means known in the art, for example, JPEG, or PDF, creating a HIPAA compliant specimen photo archive.

In one embodiment, records of gross photographs are included along with any special tissue procurement protocols. In one embodiment, free text note section 138 of any type known in the art, such as MS Word, is available for every specimen and includes medical spell check and voice recognition capabilities (such as Dragon Naturally Speaking) In one embodiment, standard or customizable ink code section 140 is included. In one embodiment, Current Procedural Terminology (CPT) code specimen order box 142 displays at the end of every dictation and includes specimen type suggestions. This enables trained Pathology personnel to order the specimen billing code once the grossing is completed-maximizing laboratory reimbursement by minimizing medical coding errors. Any CPT codes known in the art can be displayed, including codes for special stains and decalcification orders when appropriate.

In one embodiment, by replacing actual patient information and demographics with mock up patient information and demographics, the apparatus can function in a test mode for evaluation by potential users or in a training mode for training users of the apparatus. For example, the training mode can be used as part of Pathologist's Assistant training programs in universities or other educational institutions.

In one embodiment, a customizable user signature, associated with the user log-in, generates at the end of the dictation using voice recognition or touch screen capabilities. In one embodiment, once the dictation is complete (with boxes that are not required to be filled out, shade out, depending on the specifics) and saved, the drop down options disappear, generating a final patient pathology report using any means known in the art, for example, .NET crystal reports. In one embodiment, once the report is saved, the print template button is enabled. In one embodiment, once the saved template is selected, from the dictation page, the report is saved to a Structured Query Language (SQL) server database using a unique identification based on the selected patient identifiers. In one embodiment, the Existing template group is generated whenever a template is saved, having a number in the title, increasing and indicating the total number of existing templates for that patient. Example “Existing (2)”. A template option of the appropriate name also is added to the Existing group as a selectable sub-item.

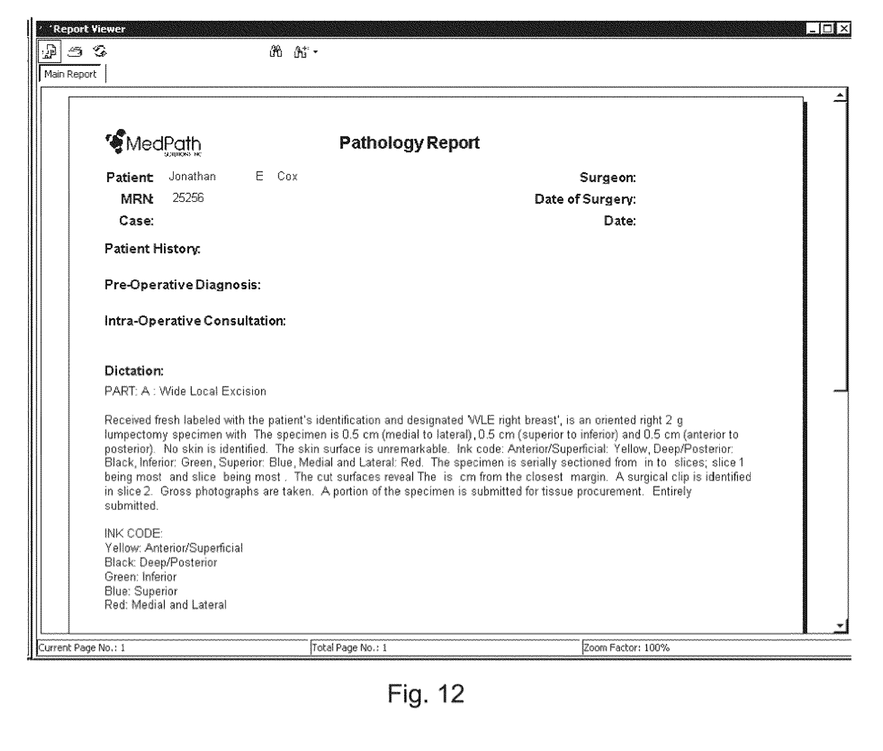

To generate FIG. 12, the user selected tab 144 for Save Template in FIG. 10 or 11. This pathology report is automatically generated by gathering, sorting, and presenting information obtained in the previous figures. In one embodiment, the pathology report is presented using any means known in the art, for example, .NET crystal reports, and has at least three options for enable the user to save the report in any format known in the art, for example, PDF, MS. WORD, and MS EXCEL. The pathology report can be saved in to the patient file so that the Pathologist can access the report and completed their part of the microscopic diagnosis, or the report can be printed out and handled in the same manner.

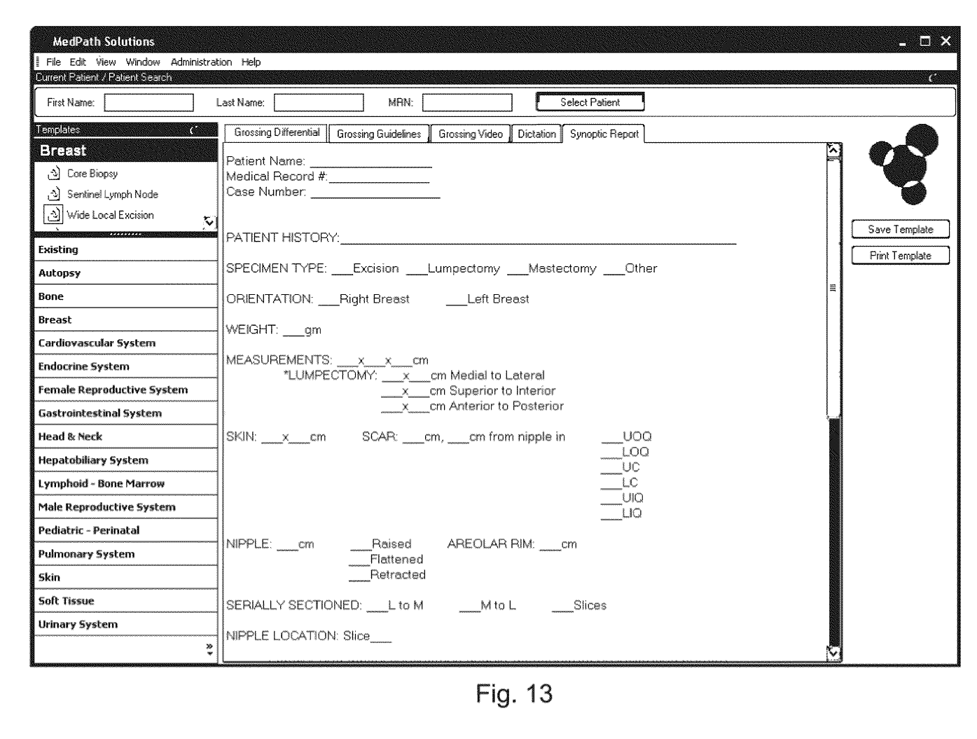

To generate FIG. 13, the user has selected tab 146 for Synoptic Report in FIG. 10 or 11. The information entered in FIGS. 10 and 11 is extracted from the Dictation tab and transferred to the standardized Synoptic Report. In one embodiment, a standardized Synoptic Report is generated using any means known in the art, for example, .NET crystal reports, upon saving of a template. This report also has options for the user to save the report in various formats, for example, PDF, MS. WORD, and MS EXCEL. This allows for the option of Pathologists reviewing the grossing pathology report in standard dictation report format or in a standard synoptic report format or both.

In one embodiment, the Synoptic Report provides standardized terminology and pathology report structure to enable recognition of the most important findings in determining treatment, for example, by providing standardized nomenclature, a set of universally required findings, and a consistent report structure. However, the report standardization and format preserves the user's flexibility to offer individual diagnostic opinions on a case by case basis by including synoptic elements with narrative descriptions. Thus, a clinician can identify clinically significant elements, while still having access to more subjective material, such as the user's opinion regarding a specimen.

Editing and addendums of saved patient reports are enabled in the apparatus until final sign out, for example, regarding any gross residual tissue, such as decalcification and/or additional tissue sections that may need to be submitted for a case. Once the patient file is saved and the final pathology report is completed, the apparatus is enabled with a customized chosen time frame, for example, 2 months post completion, to enable structured data extraction for cancer registry and research databases.

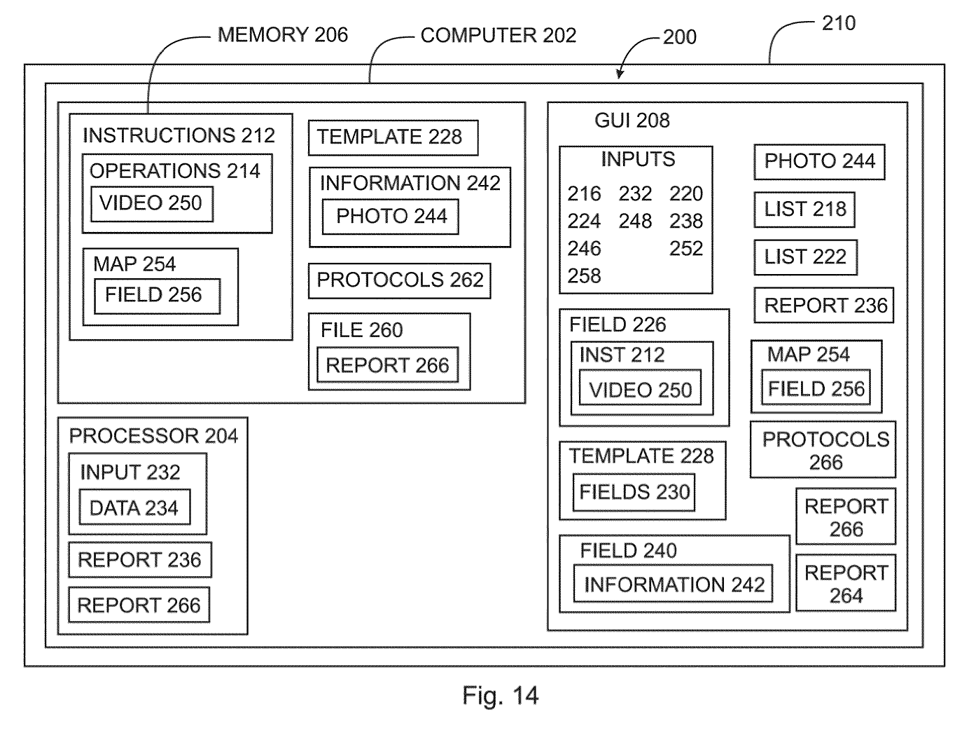

FIG. 14 is a block diagram of computer-based apparatus 200 for guiding surgical anatomic pathology operations. Apparatus 200 includes at least one specially programmed computer 202, processor 204, memory element 206, and graphical user interface (GUI) 208. Computer 202 can be any computer or plurality of computers known in the art. In one embodiment, the computer is located in single location with which apparatus 200 is associated, for example, location 210. In another embodiment (not shown), all or parts of the computer are remote from a location with which apparatus 200 is associated. In one embodiment, one or more computers 202 are located at respective specimen processing stations. Processor 204 can be any processor known in the art. Memory element 206 and GUI 208 can be any memory element or GUI, respectively, known in the art.

The memory element is for storing a plurality of instructions 212 for guiding surgical anatomic pathology operations 214. Instructions 212 can include any instructions known in the art and operations 214 can include any surgical anatomic pathology operations known in the art. The GUI is for: receiving input 216 selecting an existing patient or identifying a new patient; displaying a list 218 of human body organs or organ systems; and receiving input 220 selecting an organ or organ system from the list of human body organs or organ systems, for example, as shown in FIG. 1. List 218 can include any human body organ or organ system known in the art. The GUI is for: displaying list 222 including at least one specimen type applicable to the selected human body organ or organ system, for example, as shown in FIG. 2; and receiving input 224 selecting a specimen type from list 222, for example, as shown in FIG. 3. List 222 can include any specimen type known in the art.

The processor is for selecting instructions 212 for a surgical anatomic pathology operation applicable to the selected specimen type, and populating, using the GUI, field 226 with the instructions 212 applicable to the selected specimen type, for example, as shown in FIG. 5. The processor also displays, using the GUI, dictation template 228, applicable to the surgical anatomic pathology operation. The template includes respective prompts and respective fields 230. The GUI receives input 232 via respective fields including data 234 related to performance of the surgical anatomic pathology operation, for example, as shown in FIG. 10. The processor is for generating pathology report 236 for the existing patient or the new patient including data 234. In one embodiment, for example, as shown in FIG. 12, the processor displays the report on the GUI.

In one embodiment, the memory element is for storing a plurality of dictation templates 228, and the processor is for selecting the dictation template for display from the plurality of dictation templates, for example, by determining which of the stored templates is most applicable to the surgical anatomic pathology operation.

In one embodiment, the memory element is for storing a plurality of standardized prompts and information 242 applicable to respective human body organs or organ systems. The GUI is for receiving input 238 selecting grossing differentials, and the processor is for selecting standardized prompts and information, applicable to the selected human body organ or organ system, from the plurality of standardized prompts and information. The GUI populates field 240 on the GUI with the selected standardized prompts and information 242, for example, as shown in FIG. 3. In one embodiment, the standardized prompts and information include respective photographs 244 applicable to human body organs or organ systems 214. As shown for example in FIG. 4, the GUI is for displaying, using the processor, at least one respective photograph 244 applicable to the selected human body organ or organ system.

In one embodiment, instructions 212 include respective videos 250 applicable to surgical anatomic pathology operations 214. As shown for example in FIG. 9, the GUI is for displaying, using the processor, respective video 250 applicable to the surgical anatomic pathology operation.

In one embodiment, instructions 212 include at least one diagram-map 254, for example, as shown in FIG. 7. The processor identifies a respective diagram-map 254 applicable to the surgical anatomic pathology operation, and displays, using the GUI, the respective diagram-map. In one embodiment, the respective diagram-map includes at least one field 256. The GUI is for receiving data input 258 including respective locations for tissue samples taken as part of the surgical anatomic pathology operation. The processor is for saving the data input to a file for the existing patient or the new patient. In one embodiment, file 260 for the existing patient or the new patient is stored in the memory element.

In one embodiment, the GUI displays facility customizable standardized instructions and protocols 262 to procure tissue for research and clinical data analysis, for example, as shown in FIG. 8. The standardized instructions and protocols are specimen type specific. The facility customizable standardized instructions and protocols 262 are stored in the memory element and the processor can accept input to customize facility customizable standardized instructions and protocols 262.

The processor generates pathology report 264, for example, as shown in FIG. 12, using applicable data obtained via the operations described supra. Report 264 is displayed on the GUI. In one embodiment, the pathology report is saved to patient file 260 so that the Pathologist can access the report and completed their part of the microscopic diagnosis, or the report can be printed out and handled in the same manner.

The processor generates pathology report 266, for example, as shown in FIG. 13. Report 266 is displayed on the GUI. In one embodiment, the synoptic report is saved to patient file 260.

Apparatus 100 provides guided decision support that emphasizes and ensures patient safety, minimizes redundancies and transposed errors, compensates for lack of national standards for grossing, enables automatic dictation, and facilitates tissue sampling and tissue procurement for research. Apparatus 100 is compliant with recommendation of the College of Pathologists regarding final synoptic reports that the Pathologist complete for microscopic diagnosis and supports future cancer reporting guidelines for grossing.

In one embodiment, the system generates a data file of patient demographics and pathology results, for example, tumor data, for cancer or research reporting. In one embodiment, the system is compliant with Health Insurance Portability and Accountability Act (HIPPA) requirements. In one embodiment, the system tracks specimen data for use with audit trails.

In one embodiment, the system can be used in a “teaching” mode, for example, available to pathologist assistant training schools or students, using mock up patient demographics.

According to aspects disclosed herein there is provided a standardized method for guiding decision support for surgical anatomic pathology operations, for example, as shown in FIGS. 1-14.

The apparatus and method described supra:
1. Increases hospital-lab profits by minimizing medical coding errors.
2. Increase efficiency and accuracy of surgical grossing specimen, reducing patient report turn around time.
3. Minimizes transcription errors and costs by enabling voice recognition and touch screen capabilities.
4. Provides a chain of specimen handling with custom electronic signatures.
5. Uses forced data entry to avoid incomplete dictation specimen reports.
6. Provides a simplified approach to handling unfamiliar specimens and routine autopsy cases.

Thus, it is seen that the objects of the disclosure are efficiently obtained, although changes and modifications to the disclosure should be readily apparent to those having ordinary skill in the art, without departing from the spirit or scope of the disclosure as claimed. Although the disclosure is described by reference to an example embodiment, it is clear that variations can be made without departing from the scope or spirit of the disclosure as described.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the disclosed disclosure.

What is claimed is:

1. A computer-based method for guiding decision support for surgical anatomic pathology operations, comprising:
storing, in a memory element of at least one specially programmed computer, a plurality of instructions for guiding surgical anatomic pathology operations;
receiving, using a graphical user interface (GUI) for the at least one specially programmed computer, an input selecting an existing patient or identifying a new patient;
displaying, using the GUI and a processor for the at least one specially programmed computer, a list of human body organs or organ systems;
receiving, using the GUI, an input selecting an organ or organ system from the list of human body organs or organ systems;
displaying, using the GUI and the processor, a list including at least one specimen type applicable to the selected human body organ or organ system;
receiving, using the GUI, an input selecting a specimen type from the list including at least one specimen type;
populating, using the GUI and the processor, a first field with instructions, from the plurality of instructions, for guiding a surgical anatomic pathology operation applicable to the selected specimen type;
displaying, using the GUI and the processor, a dictation template with respective prompts and respective fields applicable to the surgical anatomic pathology operation;
receiving, using the GUI, an input from the respective fields including first data related to performance of the surgical anatomic pathology operation; and,
generating, using the processor, a pathology report for the existing patient or the new patient including the first data.

2. The method of claim 1 further comprising:
storing, in the memory element, a plurality of dictation templates; and,
selecting, using the processor, a dictation template, from the plurality of dictation templates, applicable to the surgical anatomic pathology operation.

3. The method of claim 1 further comprising:
storing, using the memory element, a plurality of standardized prompts and information applicable to respective human body organs or organ systems;
selecting, using the processor, standardized prompts and information, applicable to the selected human body organ or organ system, from the plurality of standardized prompts and information; and,
populating, using the processor, a second field on the GUI with the selected standardized prompts and information.

4. The method of claim 3 wherein:
the plurality of standardized prompts and information includes respective photographs; and,
populating the second field includes displaying a respective photograph applicable to the selected human body organ or organ system.

5. The method of claim 1 further comprising selecting, from the plurality of instructions for guiding surgical anatomic pathology operations and using the processor, the instructions applicable to the surgical anatomic pathology operation.

6. The method of claim 1 wherein:
storing a plurality of instructions for guiding surgical anatomic pathology operations includes storing respective videos; and,
populating the first field with instructions includes displaying a respective video.

7. The method of claim 1 further comprising:
storing, in the memory element, at least one diagram-map for use in showing respective locations for tissue samples;
identifying, using the processor, a respective diagram-map applicable to the surgical anatomic pathology operation;
populating the respective diagram-map with demographics for the existing patient or the new patient; and,
displaying, using the GUI and the processor, the respective diagram-map.

8. The method of claim 1 further comprising displaying, using the GUI and the processor, standardized instructions and protocols regarding tissue procurement for research and clinical data analysis.

9. The method of claim 1 further comprising:
storing, in the memory element, the standardized instructions and protocols regarding tissue procurement;
accepting, using the processor, input regarding the standardized instructions and protocols regarding tissue procurement; and,
modifying, using the processor, the stored standardized instructions and protocols regarding tissue procurement according to the input, wherein the standardized instructions and protocols are specimen type specific.

10. A computer-based apparatus for guiding decision support for surgical anatomic pathology operations, comprising:
a memory element for at least one specially programmed computer;
a processor for the at least one specially programmed computer; and,
a graphical user interface (GUI) for the at least one specially programmed computer, wherein:
the memory element is for storing a plurality of instructions for guiding surgical anatomic pathology operations;
the GUI is for:
receiving an input selecting an existing patient or identifying a new patient;
displaying, using the processor, a list of human body organs or organ systems;
receiving an input selecting an organ or organ system from the list of human body organs or organ systems;
displaying, using the processor, a list including at least one specimen type applicable to the selected human body organ or organ system; and,
receiving an input selecting a specimen type from the list including at least one specimen type;
the processor is for populating, using the GUI, a first field with instructions, from the plurality of instructions, for guiding a surgical anatomic pathology operation applicable to the selected specimen type;
the GUI is for:
displaying, using the processor, a dictation template with respective prompts and respective fields applicable to the surgical anatomic pathology operation; and,
receiving an input from the respective fields including first data related to performance of the surgical anatomic pathology operation; and,
the processor is for generating a pathology report for the existing patient or the new patient including the first data.

11. The apparatus of claim 10 wherein:
the memory element is for storing a plurality of dictation templates; and,
the processor is for selecting a dictation template, from the plurality of dictation templates, applicable to the surgical anatomic pathology operation.

12. The apparatus of claim 10 wherein:
the memory element is for storing a plurality of standardized prompts and information applicable to respective human body organs or organ systems;
the processor is for selecting standardized prompts and information, applicable to the selected human body organ or organ system, from the plurality of standardized prompts and information; and,
the processor is for populating a second field on the GUI with the selected standardized prompts and information.

13. The apparatus of claim 12 wherein:
the plurality of standardized prompts and information includes respective photographs; and,
the GUI is for displaying, using the processor, a respective photograph applicable to the selected human body organ or organ system.

14. The apparatus of claim 10 wherein the processor is for selecting, from the plurality of instructions for guiding surgical anatomic pathology operations, the instructions applicable to the surgical anatomic pathology operation.

15. The apparatus of claim 10 wherein:
storing a plurality of instructions for guiding surgical anatomic pathology operations includes storing respective videos; and,
populating the first field with instructions includes displaying a respective video.

16. The apparatus of claim 10 wherein:
the memory element is for storing at least one diagram-map for use in showing respective locations for tissue samples;
the processor is for identifying a respective diagram-map applicable to the surgical anatomic pathology operation;
the processor is for populating the respective diagram-map with demographics for the existing patient or the new patient; and,
the GUI is for displaying, using the processor, the respective diagram-map.

17. The apparatus of claim 10 wherein the GUI is for displaying, using the processor, standardized instructions and protocols regarding tissue procurement for research and clinical data analysis.

18. The apparatus of claim 10 wherein:
the memory element is for storing the standardized instructions and protocols regarding tissue procurement;
the processor is for:
accepting input regarding the standardized instructions and protocols regarding tissue procurement; and,
modifying the stored standardized instructions and protocols regarding tissue procurement according to the input; and,
the standardized instructions and protocols are specimen type specific.

19. A computer-based apparatus for guiding decision support for surgical anatomic pathology operations, comprising:
a memory element for at least one specially programmed computer;
a processor for the at least one specially programmed computer; and,
a graphical user interface (GUI) for the at least one specially programmed computer, wherein:
the memory element is for:
storing a plurality of standardized prompts and information applicable to respective human body organs or organ systems;
storing a plurality of instructions for guiding surgical anatomic pathology operations; and,
storing a plurality of dictation templates;
the GUI is for:
receiving an input selecting an existing patient or identifying a new patient;
displaying, using the processor, a list of human body organs or organ systems; and,
receiving an input selecting an organ or organ system from the list of human body organs or organ systems;
the processor is for:
selecting standardized prompts and information, applicable to the selected human body organ or organ system, from the plurality of standardized prompts and information; and,
populating a first field on the GUI with the selected standardized prompts and information;
the GUI is for:
displaying, using the processor, a list including at least one specimen type applicable to the selected human body organ or organ system; and,
receiving an input selecting a specimen type from the list including at least one specimen type;
the processor is for:
populating, using the GUI, a second field with instructions, from the plurality of instructions, for guiding a surgical anatomic pathology operation applicable to the selected specimen type; and,
selecting a dictation template, from the plurality of dictation templates, applicable to the surgical anatomic pathology operation;
the GUI is for:
displaying, using the processor, a dictation template with respective prompts and respective fields applicable to the surgical anatomic pathology operation; and,
receiving an input from the respective fields including first data related to performance of the surgical anatomic pathology operation; and,
the processor is for generating a pathology report for the existing patient or the new patient including the first data.
